(19) United States
(12) Patent Application Publication
(10) Pub. No.: US 2026/0180728 A1
(43) Pub. Date: Jun. 25, 2026

(54) ANTENNA PORT ENTRIES FOR MORE THAN 4 LAYER PHYSICAL UPLINK SHARED CHANNEL (PUSCH)

(71) Applicant: Telefonaktiebolaget LM Ericsson (publ), Stockholm (SE)

(72) Inventors: Andreas NILSSON, Göteborg (SE); Sven JACOBSSON, Västra Frölunda (SE); Jianwei ZHANG, Solna (SE); Shiwei GAO, Nepean (CA)

(21) Appl. No.: 19/126,905

(22) PCT Filed: Nov. 2, 2023
(86) PCT No.: PCT/IB2023/061086

§ 371 Date: May 2, 2025

Related U.S. Application Data
(60) Provisional application No. 63/422,592, filed on Nov. 4, 2022.

(51) Int. Cl. H04L 5/00

(52) U.S. Cl. CPC H04L 5/0007

(57) ABSTRACT

A method, system and apparatus are disclosed. A wireless device (WD) configured to communicate with a network node is described. The WD is configured for allocating demodulation reference signal (DMRS) ports for physical uplink shared channel (PUSCH) transmission. The WD is configured to receive an indication of a codepoint of an antenna port field for scheduling a PUSCH, the codepoint indicating an allocation of DMRS ports to at least a first code division multiplexing, CDM, group, the indication indicating at least 5 PUSCH, layers. The WD is also configured to determine a DMRS port configuration based at least in part on the codepoint and to transmit reference signaling according to the determined DMRS port configuration.

### FIELD

The present disclosure relates to wireless communications, and in particular, to antenna port entries/configuration for more than four layer Physical Uplink Shared Channel (PUSCH).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile wireless devices (WD), as well as communication between network nodes and between WDs. The 3GPP is also developing standards for Sixth Generation (6G) wireless communication networks.

### NR Frame Structure and Resource Grid

Some existing NR systems use Cyclic Prefix Orthogonal Frequency Domain Multiplexing (CP-OFDM) in both downlink (i.e., from a network node, gNB, or base station, to a WD) and uplink (i.e., from WD to network node). Direct Fourier Transform (DFT) spread OFDM is also supported in the uplink. In the time domain, NR downlink and uplink may be organized into equally-sized subframes of 1 ms each. A subframe may be further divided into multiple slots of equal duration. The slot length depends on subcarrier spacing. For example, for subcarrier spacing of Δf=15 kHz, there may be only one slot per subframe where each slot includes 14 OFDM symbols.

Data scheduling in NR is typically on a slot basis where the first two symbols contain physical downlink control channel (PDCCH) and the remainder contains physical shared data channel, either physical downlink shared channel (PDSCH) or physical uplink shared channel (PUSCH). FIG. 1 is a timing diagram of an example NR time-domain structure with 15 kHz subcarrier spacing, which depicts an example slot configuration including a 14-symbol slot.

Different subcarrier spacing values may be supported in NR. The supported subcarrier spacing values (also referred to as different numerologies) are given by Δf=(15×2^{μ}) kHz where μ∈0, 1, 2, 3, 4. Δf=15 kHz is the basic subcarrier spacing. The slot durations at different subcarrier spacings are given by 1/2^{μ} ms.

In the frequency domain, a system bandwidth is divided into resource blocks (RBs), each corresponding to 12 contiguous subcarriers. The RBs are numbered starting with 0 from one end of the system bandwidth. One OFDM subcarrier during one OFDM symbol interval forms one resource element (RE). FIG. 2 is a graph which illustrates an example NR physical time-frequency resource grid, where only one resource block (RB) within a 14-symbol slot is shown.

Downlink (DL) PDSCH transmissions may be either dynamically scheduled, i.e., in each slot the network node/gNB transmits downlink control information (DCI) over Physical Downlink Control Channel (PDCCH) about which WD data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including, e.g., DCI format 1_0, DCI format 1_1, and DCI format 1_2.

Similarly, uplink (UL) PUSCH transmission may also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include, e.g., DCI format 0_0, DCI format 0_1, and DCI format 0_2.

### DMRS Configuration

Demodulation reference signals (DM-RS) may be used for coherent demodulation of physical layer data channels, i.e., Physical Downlink Shared Channel (PDSCH) and Physical Uplink Shared Channel (PUSCH), as well as of Physical Downlink Control Channel (PDCCH). The DM-RS may be confined to resource blocks carrying the associated physical layer channel and may be mapped on allocated resource elements of the time-frequency resource grid such that the receiver can efficiently handle time/frequency-selective fading of radio channels.

The mapping of DM-RS to resource elements may be configurable in both frequency and time domains. For example, in some existing systems, there are two mapping types in the frequency domain, i.e., type 1 and type 2. In addition, there are two mapping types in the time domain, i.e., mapping type A and type B, which define the symbol position of the first OFDM symbol containing DM-RS within a transmission interval.

The DM-RS mapping in the time domain can further be single-symbol based or double-symbol based, where the latter means that DM-RS is mapped in pairs of two adjacent OFDM symbols. For single symbol based DMRS, a WD can be configured with one, two, three, or four single-symbol DM-RS in a slot. For double-symbol based DMRS, a WD can be configured with one or two such double-symbol DM-RS in a slot. In scenarios with low Doppler, it may be sufficient to configure front-loaded DM-RS only, i.e., one single-symbol DM-RS or one double-symbol DM-RS, whereas in scenarios with high Doppler, additional DM-RS will be required in a slot.

FIG. 3 shows an example of type 1 front-loaded DM-RS with single-symbol (Graph a), type 1 front loaded double-symbol DM-RS (Graph b), type 2 front loaded single-symbol DM-RS (Graph c) and type 2 front loaded double-symbol DM-RS (Graph d). FIG. 3 shows time domain mapping type A with first DM-RS in the third OFDM symbol of a transmission interval of 14 symbols. In FIG. 3, type 1 and type 2 differ with respect to both the mapping structure and the number of supported DM-RS code division multiplexing (CDM) groups where type 1 support 2 CDM groups and Type 2 support 3 CDM groups.

A DM-RS antenna port may be mapped to the resource elements within one CDM group only. For single-symbol DM-RS, two antenna ports may be mapped to each CDM group, whereas for double-symbol DM-RS four antenna ports may be mapped to each CDM group. Hence, for DM-RS type 1 the maximum number of DM-RS ports is four for a single-symbol based DMRS configuration and eight for double-symbol based DMRS configuration. For DM-RS type 2, the maximum number of DM-RS ports is six for a single-symbol based DMRS configuration and twelve for double-symbol based DMRS configuration.

For example, an orthogonal cover code (OCC) of length 2 (i.e., [+1, +1] or [+1, −1]) may be used to separate antenna ports mapped in the same two resource elements within a CDM group. The OCC may be applied in the frequency domain (FD) and/or in time domain (TD) when double-symbol DM-RS is configured. This is illustrated in FIG. 3 for CDM group 0, for example.

In 3GPP NR Technical Release 15 (3GPP Rel-15), the mapping of a PDSCH DM-RS sequence r (m), m=0, 1, . . . on antenna port p and subcarrier k in OFDM symbol l for the numerology index μ is specified in 3GPP Technical Standard (TS) 38.211 as:

$$a \text{?} = {β}_{PDSCH}^{DMRS} w \text{?} ( {k}^{′} ) w \text{?} ( \text{?} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$\text{?} \text{indicates text missing or illegible when filed}$$

where w_{f}(k′) represents a frequency domain length 2 OCC code and wₜ(l′) represents a time domain length 2 OCC code. Table 1 and Table 2 below list the PDSCH DM-RS mapping parameters for configuration type 1 and type 2, respectively.

TABLE 1
PDSCH DM-RS mapping parameters for configuration type 1.

| | CDM | | w_{f}(k′) | | w_{f}(l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DM-RS mapping parameters for configuration type 2.

| | CDM | | w_{f}(k′) | | w_{f}(l′) | |
|---|---|---|---|---|---|---|
| p | group λ | Δ | k′ = 0 | k′ = 1 | l′ = 0 | l′ = 1 |
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

For PDSCH mapping type A, DM-RS mapping is relative to slot boundary. That is, the first front-loaded DM-RS symbol in DM-RS mapping type A is in either the 3rd or 4th symbol of the slot. In addition to the front-loaded DM-RS, type A DM-RS mapping may consist of up to 3 additional DM-RS. If the scheduled PDSCH duration is shorter than the full slot, the positions of the DMRS changes according to the specification (i.e., 3GPP TS 38.211).

FIG. 4 is a timing diagram which illustrates examples of DM-RS configurations for PDSCH Mapping Type A. The example in FIG. 4 assumes that the PDSCH duration is the full slot. A PDSCH length of 14 symbols is assumed in the examples, although other symbol lengths may be utilized.

FIG. 5 is a timing diagram which illustrates examples of DM-RS configurations for PDSCH Mapping Type B. For PDSCH mapping type B, DM-RS mapping is relative to transmission start. That is, the first DM-RS symbol in DM-RS mapping type B is in the first symbol in which type B PDSCH starts. Some examples of DM-RS for mapping type A are shown in FIG. 5.

The same DMRS design for PDSCH may also be applicable for PUSCH when transform precoding is not enabled, where the sequence r(m) may be mapped to the intermediate quantity

$${\tilde{a}}_{k , l}^{( \tilde{p} j , μ )}$$

for DMRS port \tilde{p}ⱼ according to:

$${\tilde{a}}_{k , l}^{( {\tilde{p}}_{j} , μ )} = w \text{?} ( {k}^{′} ) w \text{?} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , υ - 1$$

$$\text{?} \text{indicates text missing or illegible when filed}$$

where w_{f}(k′), wₜ(l′), and Δ are given by Tables 6.4.1.1.3-1 and 6.4.1.1.3-2 in 3GPP TS 38.211, which are reproduced below as Table 3A and Table 3B, and v is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

may be precoded, multiplied with the amplitude scaling factor

$${β}_{PUSCH}^{DMRS}$$

in order to conform to the transmit power specified in clause 6.2.2 of 3GPP TS 38.214, and mapped to physical resources according to

$$[ \begin{matrix}{a}_{k , l}^{( {p}_{0} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{0} , μ )} \\ ⋮ \\ {\tilde{a}}_{k , l}^{( {\tilde{p}}_{υ - 1} , μ )}\end{matrix} ]$$

where
the precoding matrix W is given by clause 6.3.1.5 of 3GPP TS 38.211;
{p₀, . . . , p_{ρ-1}} is a set of physical antenna ports used for transmitting the PUSCH; and
{\tilde{p}₀, . . . , \tilde{p}ᵥ₋₁} is a set of DMRS ports for the PUSCH.

TABLE 3A
Parameters for PUSCH DM-RS configuration type 1.

| | | CDM | | w_{f}(k′) | | w_{f}(l′) | |
|---|---|---|---|---|---|---|---|
| \tilde{p} | | group λ | Δ | k′ = 0 | k′ = 1 | l′ = 0 | l′ = 1 |
| | 0 | 0 | 0 | +1 | +1 | +1 | +1 |
| | 1 | 0 | 0 | +1 | −1 | +1 | +1 |
| | 2 | 1 | 1 | +1 | +1 | +1 | +1 |
| | 3 | 1 | 1 | +1 | −1 | +1 | +1 |
| | 4 | 0 | 0 | +1 | +1 | +1 | −1 |
| | 5 | 0 | 0 | +1 | −1 | +1 | −1 |
| | 6 | 1 | 1 | +1 | +1 | +1 | −1 |
| | 7 | 1 | 1 | +1 | −1 | +1 | −1 |

TABLE 3B
Parameters for PUSCH DM-RS configuration type 2.

| | CDM | | w_{f}(k′) | | w_{f}(l′) | |
|---|---|---|---|---|---|---|
| \tilde{p} | group λ | Δ | k′ = 0 | k′ = 1 | l′ = 0 | l′ = 1 |
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

### DMRS Sequence Generation

The DMRS sequence r (n) for both PDSCH and PUSCH is defined by:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c (i) is defined in clause 5.2.1 of 3GPP TS 38.211. The pseudo-random sequence generator is initialized with:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame: and
For PDSCH DMRS,

$${N}_{ID}^{0} , {N}_{ID}^{1} ∈ \{ 0 , 1 , … , 65535 \}$$

are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI;
For PUSCH DMRS,

$${N}_{ID}^{0} , {N}_{ID}^{1} ∈ \{ 0 , 1 , … , 65535 \}$$

are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant;
For PUSCH DMRS,

$${N}_{ID}^{0} ∈ \{ 0 , 1 , … , 65535 \}$$

is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;
For PUSCH DMRS,

$${N}_{ID}^{0} ∈ \{ 0 , 1 , … , 65535 \}$$

is given by the higher-layer parameter scramblingID0 in the DMRS-UplinkConfig IE if provided and the PUSCH is scheduled by DCI format 0_1 or 0_2, or by a PUSCH transmission with a configured grant;

$${N}_{ID}^{{\overline{n}}_{SCID}^{\overline{λ}}} = {N}_{ID}^{cell} otherwise ;$$

$${\overline{n}}_{SCID}^{\overline{λ}} and \overline{λ} are given by :$$

if the higher-layer parameter dmrs-Downlink in the DMRS-DownlinkConfig 1E or dmrs-Uplink in the DMRS-UplinkConfig IE is provided, the corresponding

$${\overline{n}}_{SCID}^{\overline{λ}} and \overline{λ}$$

are determined as:

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group index;
otherwise by:

$${\overline{n}}_{SCID}^{\overline{λ}} = {n}_{SCID}$$

$$\overline{λ} = 0$$

The quantity n_{SCID} ∈{0, 1} is given by the DM-RS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a configured grant; otherwise n_{SCID}=0.

### DMRS Ports Signalling

DMRS port(s) for a PDSCH or a PUSCH are signalled in the corresponding scheduling DCI. In addition to the DMRS ports, the number of CDM groups that are not allocated for PDSCH or PUSCH and also the number of front-loaded DMRS symbols are dynamically signalled in the DCI.

In PUSCH scheduling, the number of layers is indicated separately from DMRS ports signalling in the DCI. While for PDSCH scheduling, the number of layers and DMRS ports are signalled jointly in the DCI.

An “antenna port(s)” bit field in DCI is used. An example for type 1 DMRS with rank=1 and up to two maximum number of front-loaded DMRS OFDM symbols for PUSCH is shown in Table 4 and Table 5 below, which are copied from 3GPP TS 38.212. In this example, 4 bits are used. Note that DMRS type and maximum number of front-loaded DMRS symbols are semi-statically configured by RRC.

TABLE 4
Antenna port(s), transform precoder is disabled, dmrs-
Type = 1, maxLength = 2, rank = 1

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 5
Antenna port(s), transform precoder is disabled, dmrs-
Type = 1, maxLength = 2, rank = 2

| | Number of DMRS CDM | DMRS | Number of front- |
|---|---|---|---|
| Value | group(s) without data | port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Another example for type 1 DMRS with up to two maximum number of front-loaded DMRS OFDM symbols for PDSCH is shown in Table 6 below, which is copied from 3GPP TS 38.212.

TABLE 6
Antenna port(s) (1000 + DMRS port), dmrs-Type = 1, maxLength = 2 (from TS 38.212 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | Number |
| | CDM | | Number | | CDM | | of |
| | group(s) | | of front- | | group(s) | | front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

### DMRS Agreements in Rel-18

In RAN1 #110-bis it was agreed that the 3GPP Technical Release 18 (3GPP Rel-18) DMRS will be using extended using frequency duplex orthogonal cover code (FD-OCC) length 4 instead of FD-OCC length 2 per CDM group. The FD-code will either be based on Walsh matrix (Hadamard code), as shown in the example of Table 7 below.

TABLE 7
Walsh matrix (Hadamard code) for length 4 FD-OCC

| FD-OCC | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | −1 |
| 2 | +1 | +1 | −1 | −1 |
| 3 | +1 | −1 | −1 | +1 |

Or, cyclic shifts may be configured with {0, π/2, π, 3π/2}, as shown in Table 8 below.

TABLE 8
Cyclic shifts with {0, π, π/2, 3π/2} for length 4 FD-OCC

| FD-OCC | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | −1 |
| 2 | +1 | +j | −1 | −j |
| 3 | +1 | −j | −1 | +j |

It was further agreed that the 3GPP Rel-18 DMRS Ports that are identical with the 3GPP Rel-15 DMRS ports should have the same antenna port number, while the new 3GPP Rel-18 DMRS ports should use new antenna port numbers. This is illustrated in Table 9 and Table 10 below showing an agreement from RAN1 #110-bis for DMRS type 1 and DMRS type 2, respectively. Note that the code corresponding to the FD-OCC index can be seen in Table 7 and Table 8:

TABLE 9
Agreed antenna port numbers for Rel-18 DMRS for DMRS Type 1

| | CDM group | FD-OCC | TD-OCC |
|---|---|---|---|
| p | index | index | index |
| 0 | 0 | 0 | 0 |
| 1 | 0 | 1 | 0 |
| 2 | 1 | 0 | 0 |
| 3 | 1 | 1 | 0 |
| 4 | 0 | 0 | 1 |
| 5 | 0 | 1 | 1 |
| 6 | 1 | 0 | 1 |
| 7 | 1 | 1 | 1 |
| 8 | 0 | 2 | 0 |
| 9 | 0 | 3 | 0 |
| 10 | 1 | 2 | 0 |
| 11 | 1 | 3 | 0 |
| 12 | 0 | 2 | 1 |
| 13 | 0 | 3 | 1 |
| 14 | 1 | 2 | 1 |
| 15 | 1 | 3 | 1 |

TABLE 10
Agreed antenna port numbers for Rel-18 DMRS for
DMRS Type 2 Terminology on eType1 and eType2

| | CDM group | FD-OCC | TD-OCC |
|---|---|---|---|
| p | index | index | index |
| 0 | 0 | 0 | 0 |
| 1 | 0 | 1 | 0 |
| 2 | 1 | 0 | 0 |
| 3 | 1 | 1 | 0 |
| 4 | 2 | 0 | 0 |
| 5 | 2 | 1 | 0 |
| 6 | 0 | 0 | 1 |
| 7 | 0 | 1 | 1 |
| 8 | 1 | 0 | 1 |
| 9 | 1 | 1 | 1 |
| 10 | 2 | 0 | 1 |
| 11 | 2 | 1 | 1 |
| 12 | 0 | 2 | 0 |
| 13 | 0 | 3 | 0 |
| 14 | 1 | 2 | 0 |
| 15 | 1 | 3 | 0 |
| 16 | 2 | 2 | 0 |
| 17 | 2 | 3 | 0 |
| 18 | 0 | 2 | 1 |
| 19 | 0 | 3 | 1 |
| 20 | 1 | 2 | 1 |
| 21 | 1 | 3 | 1 |
| 22 | 2 | 1 | 1 |
| 23 | 3 | 3 | 1 |

3GPP discussions have considered terminology for 3GPP Rel-18 DMRS, i.e., eType1 and eType2 DMRS ports, as follows:
For discussion purpose, example definitions of 3GPP Rel-15 DMRS ports and 3GPP Rel-18 DMRS ports are:
   3GPP Rel-15 Type 1/Type 2 DMRS ports: DMRS ports with FD-OCC length=2;
   3GPP Rel-18 eType 1/eType 2 DMRS ports: DMRS ports with FD-OCC length>2.

FIG. 6 is a chart illustrating example differences between 3GPP Rel-15 Type 1 DMRS ports and 3GPP Rel-18 eType 1 DMRS ports.

In NR, antenna port tables for 3GPP Rel-15 Type 1/Type 2 DMRS ports are specified. However, existing systems lack mechanisms for determining/selecting the antenna port tables in an effective way for 3GPP Rel-18 eType 1/eType 2 DMRS ports.

### SUMMARY

Some embodiments advantageously provide methods, systems, and apparatuses for determining antenna port entries for more than four layer PUSCH.

One or more embodiments describe solutions on how to signal, from the network to the WD, applied DMRS ports for a scheduled PUSCH transmission when the WD is configured with the extended number of orthogonal DMRS ports (e.g., to be specified in 3GPP Rel-18). The WD may be scheduled with more than four PUSCH layers.

According to an aspect, a method of allocating DMRS antenna ports for PUSCH transmission when scheduled with more than 4 PUSCH layers is described. The method comprises:
receiving an indication of a codepoint of an antenna port field in a DCI for scheduling PUSCH indicating at least one of the following:
   5 spatial layers
   6 spatial layers
   7 spatial layers
   8 spatial layers
transmitting DMRS ports according to the indication of the codepoint of the antenna port field.

In some embodiments, for 5 spatial layers, three DMRS ports are allocated to a first CDM group, and two DMRS ports are allocated to the second CDM group. The two DMRS ports in the second CDM group are mutually super orthogonal.

In some embodiments, for 5 spatial layers, three DMRS ports are allocated to a first CDM group, two DMRS ports are allocated to the second CDM group. The two DMRS ports in the second CDM group are mutually super orthogonal, and the two DMRS ports in the second CDM group are not a 3GPP Rel-15 DMRS port (i.e., a predetermined DMRS port).

In some embodiments, for 5 spatial layers, four DMRS ports are allocated to a first CDM group, and one DMRS port is allocated to the second CDM group. The DMRS port in the second CDM group is using a DMRS port that is not a 3GPP Rel-15 DMRS port (i.e., a predetermined DMRS port).

In some embodiments, for 6 spatial layers, four DMRS ports are allocated to a first CDM group, and two DMRS ports are allocated to the second CDM group. The two DMRS ports in the second CDM group are mutually super orthogonal.

In some embodiments, for 6 spatial layers, four DMRS ports are allocated to a first CDM group, and two DMRS ports are allocated to the second CDM group. The two DMRS ports in the second CDM group are mutually super orthogonal, and the two DMRS ports in the second CDM group are not a 3GPP Rel-15 DMRS port (i.e., a predetermined DMRS port).

In some embodiments, for 6 spatial layers (for DMRS Type II), two DMRS ports are allocated to a first CDM group, two DMRS ports are allocated to the second CDM group, and two DMRS ports are allocated to a third CDM group. The two DMRS ports in each CDM group are mutually super orthogonal, and the two DMRS ports in the third CDM group are not a 3GPP Rel-15 DMRS port (i.e., a predetermined DMRS port).

In some embodiments, for 6 spatial layers (for DMRS Type II), two DMRS ports are allocated to a first CDM group, two DMRS ports are allocated to the second CDM group, and two DMRS ports are allocated to a third CDM group. The two DMRS ports in each CDM group are mutually super orthogonal, and the two DMRS ports in the second CDM group and the two DMRS ports in the third CDM group are not a 3GPP Rel-15 DMRS port (i.e., a predetermined DMRS port).

In some embodiments, for 6 spatial layers (for DMRS Type II), two DMRS ports are allocated to a first CDM group, two DMRS ports are allocated to the second CDM group, and two DMRS ports are allocated to a third CDM group. The two DMRS ports in each CDM group are mutually super orthogonal and are not a 3GPP Rel-15 DMRS port (i.e., a predetermined DMRS port).

In some embodiments, a number of CDM groups are minimized by utilizing frequency domain orthogonal cover code (FD-OCC) combined with time domain orthogonal cover code (TD-OCC) for a double DMRS symbol.

Some embodiments provide for antenna port (DMRS port) indication tables. The antenna port indication tables may be designed with a predetermined robustness (e.g., good robustness) against delay spread and with a predetermined orthogonality (e.g., good orthogonality) towards legacy DMRS ports, which in turn may increase the capacity for uplink (UL) multi-user, multiple-input, multiple-output (MU-MIMO) since more WDs can be served simultaneously while still maintaining a predetermined DMRS channel estimation quality.

According to one aspect, a wireless device, WD, configured to communicate with a network node is provided. The WD is configured for allocating demodulation reference signal, DMRS, ports for physical uplink shared channel, PUSCH, transmission. The WD is configured to receive an indication of a codepoint of an antenna port field for scheduling a PUSCH, the codepoint indicating an allocation of DMRS ports to at least a first code division multiplexing, CDM, group, the indication indicating at least 5 PUSCH, layers. The WD is configured to determine a DMRS port configuration based on the codepoint and transmit reference signaling according to the determined DMRS port configuration.

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal. In some embodiments, a number of CDM groups are minimized by utilizing frequency domain orthogonal cover code, FD-OCC, combined with time domain orthogonal cover code, TD-OCC, for a double DMRS symbol.

According to another aspect, a method in a wireless device, WD, configured to communicate with a network node is provided. The WD is configured for allocating demodulation reference signal, DMRS, ports for physical uplink shared channel, PUSCH, transmission. The method includes receiving an indication of a codepoint of an antenna port field for scheduling a PUSCH, the codepoint indicating an allocation of DMRS ports to at least a first code division multiplexing, CDM, group, the indication indicating at least 5 PUSCH, layers. The method includes determining a DMRS port configuration based on the codepoint. The method also includes transmitting reference signaling according to the determined DMRS port configuration.

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal. In some embodiments, a number of CDM groups are minimized by utilizing frequency domain orthogonal cover code, FD-OCC, combined with time domain orthogonal cover code, TD-OCC, for a double DMRS symbol.

According to yet another aspect, a network node configured to communicate with a wireless device, WD, is provided. The WD is configured for allocating demodulation reference signal, DMRS, ports for physical uplink shared channel, PUSCH, transmission. The network node is configured to transmit an indication of a codepoint of an antenna port field for scheduling a PUSCH, the codepoint indicating an allocation of DMRS ports to at least a first code division multiplexing, CDM, group, the indication indicating at least 5 PUSCH, layers. The network node is configured to receive signaling, using one or more allocated DMRS ports, according to the indication of the codepoint of the antenna port field.

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal In some embodiments, a number of CDM groups are minimized by utilizing frequency domain orthogonal cover code, FD-OCC, combined with time domain orthogonal cover code, TD-OCC, for a double DMRS symbol.

According to another aspect, a method in a network node configured to communicate with a wireless device, WD, is provided. The WD is configured for allocating demodulation reference signal, DMRS, ports for physical uplink shared channel, PUSCH, transmission. The method includes transmitting an indication of a codepoint of an antenna port field for scheduling a PUSCH, the codepoint indicating an allocation of DMRS ports to at least a first code division multiplexing, CDM, group, the indication indicating at least 5 PUSCH, layers. The method includes receiving signaling, using one or more allocated DMRS ports, according to the indication of the codepoint of the antenna port field.

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, the two DMRS ports allocated to the second group exclude DMRS port types defined by a first wireless communication standard and include DMRS ports defined by a second wireless communication standard, the second wireless communication standard being released after the first wireless communication standard. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal. In some embodiments, a number of CDM groups are minimized by utilizing frequency domain orthogonal cover code, FD-OCC, combined with time domain orthogonal cover code, TD-OCC, for a double DMRS symbol.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example NR time-domain structure with 15 kHz subcarrier spacing;

FIG. 2 shows an example NR physical resource grid;

FIG. 3a-d shows an example front-loaded DM-RS for configuration type 1 and type 2;

FIG. 4 shows example DM-RS configurations for PDSCH Mapping Type A;

FIG. 5 shows example DM-RS configurations for PDSCH Mapping Type B;

FIG. 6 shows example FD-OCC lengths for according to different 3GPP releases;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating example methods implemented in a communication system including a host computer, a network node and a wireless device for executing a client application at a wireless device according to some embodiments of the present disclosure;

FIG. 10 is a flowchart illustrating example methods implemented in a communication system including a host computer, a network node and a wireless device for receiving user data at a wireless device according to some embodiments of the present disclosure;

FIG. 11 is a flowchart illustrating example methods implemented in a communication system including a host computer, a network node and a wireless device for receiving user data from the wireless device at a host computer according to some embodiments of the present disclosure;

FIG. 12 is a flowchart illustrating example methods implemented in a communication system including a host computer, a network node and a wireless device for receiving user data at a host computer according to some embodiments of the present disclosure;

FIG. 13 is a flowchart of an example process in a wireless device according to some embodiments of the present disclosure;

FIG. 14 is a flowchart of an example process in a network node according to some embodiments of the present disclosure;

FIG. 15 is a flowchart of an example process in a wireless device according to some embodiments of the present disclosure;

FIG. 16 is a flowchart of an example process in a network node according to some embodiments of the present disclosure;

FIG. 17 shows an example DMRS port numbering for DMRS type 1 using cyclic shifts according to some embodiments of the present disclosure;

FIG. 18 shows an example DMRS port numbering for DMRS type 2 using cyclic shifts according to some embodiments of the present disclosure;

FIG. 19 shows an example DMRS port numbering for DMRS type 1 with 2 front-loaded symbols using cyclic shifts according to some embodiments of the present disclosure;

FIG. 20 shows an example DMRS port numbering for DMRS type 2 with 2 front-loaded symbols using cyclic shifts according to some embodiments of the present disclosure;

FIG. 21 shows example rows in an antenna port table for rank 5 and single symbol DMRS for extended DMRS Type 1 according to some embodiments of the present disclosure;

FIG. 22 shows example rows in an antenna port table for rank 5 and single symbol DMRS for extended DMRS Type 2 according to some embodiments of the present disclosure;

FIG. 23 shows example rows in an antenna port table for rank 6 and single symbol DMRS for extended DMRS Type 1 according to some embodiments of the present disclosure;

FIG. 24 shows example rows in an antenna port table for rank 6 and single symbol DMRS for extended DMRS Type 2 according to some embodiments of the present disclosure; and

FIG. 25 shows example additional rows for antenna port tables for DMRS type I for extended DMRS for PUSCH rank 5, 6, 7 and 8 (e.g., to increase the number of REs for PUSCH (assuming SU-MIMO)) according to some embodiments of the present disclosure.

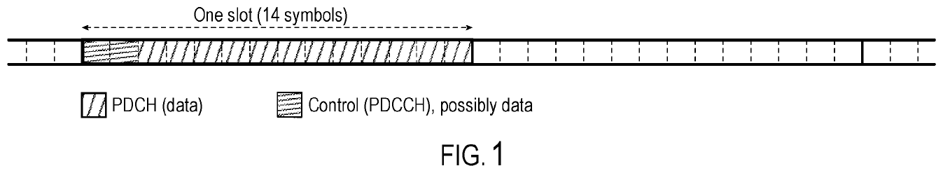

### DETAILED DESCRIPTION

Before describing in detail example embodiments, it is noted that the embodiments reside primarily in combinations of apparatus components and processing steps related to antenna port entries for more than four layer PUSCH. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “table” is used, which may refer to any one of a data structure, indication, configuration, assignment, matrix, etc. In some embodiments, the table includes information fields, bit fields, etc., and may be organized, e.g., in a two-dimensional (or generally, N-dimensional) manner, such as according to rows and columns. The table (and/or data structure, indication, configuration, assignment, etc.) may be signaled in one or more network node or WD transmissions/messages/etc., and/or may be preconfigured in the network node and/or WD.

In some embodiments, the term “DMRS” (or DM-RS) is used, which may refer to signaling such as reference signal(s) used for demodulation. For example, DMRS may be used to estimate a radio channel and/or beamformed and/or associated with a resource and/or a code division multiplexing (CDM) group. DMRS may be transmitted and/or received in uplink and/or downlink. A DMRS may be associated with and/or correspond to a port (e.g., antenna port, physical port, logical port, etc.). For example, a network node and/or WD may be configured with one or more antennas, e.g., where at least one of the antennas comprises a physical/logical port which may be mapped to and/or correspond to a DMRS port.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

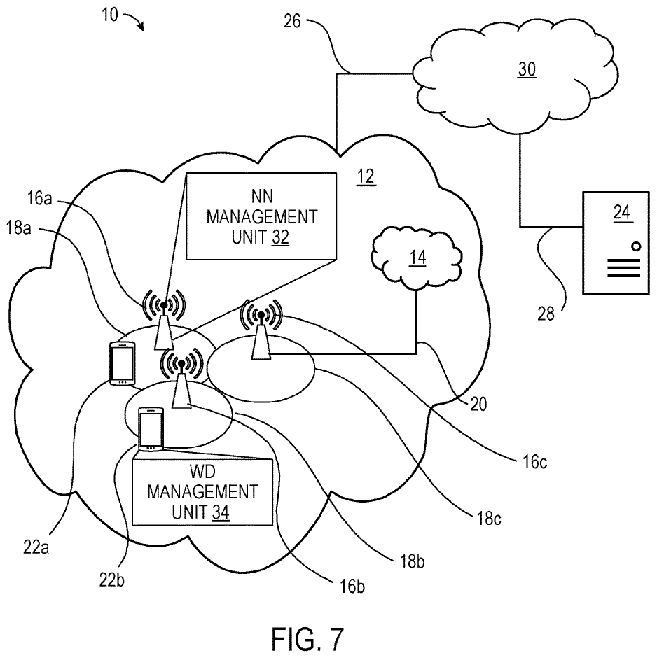

Referring again to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., transmit an indication of a codepoint of an antenna port field in downlink control information (DCI) for scheduling a physical uplink shared channel (PUSCH) the indication indicating at least one spatial layer; and receive signaling, using one or more allocated DMRS ports, according to the indication of the codepoint of the antenna port field. A wireless device 22 is configured to include a WD management unit 34 which is configured to perform any step and/or task and/or process and/or method and/or feature described in the present disclosure, e.g., receive an indication of a codepoint of an antenna port field in downlink control information (DCI) for scheduling a physical uplink shared channel (PUSCH) the indication indicating at least one spatial layer; and transmit signaling, using one or more allocated DMRS ports, according to the indication of the codepoint of the antenna port field. NN management unit 32 may be configured to perform any step and/or task and/or process and/or method and/or feature of WD management unit 34. Similarly, WD management unit 34 may be configured to perform the any step and/or task and/or process and/or method and/or features of NN management unit 32.

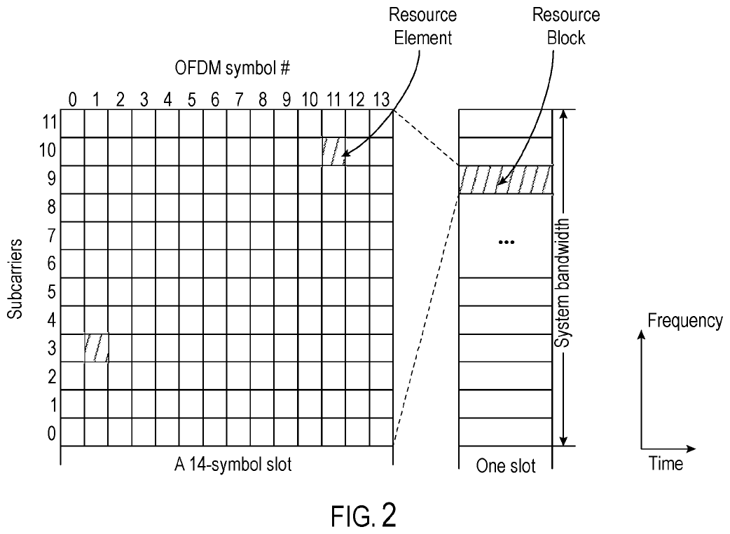

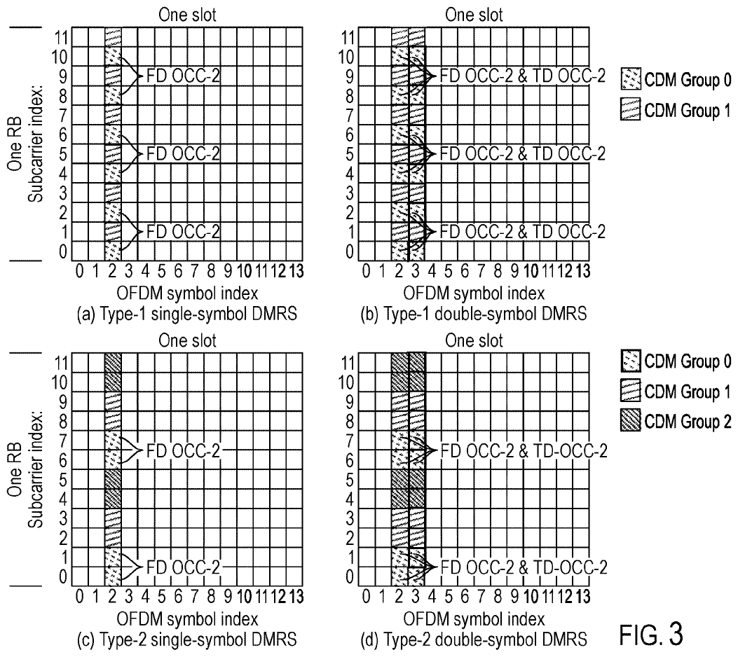

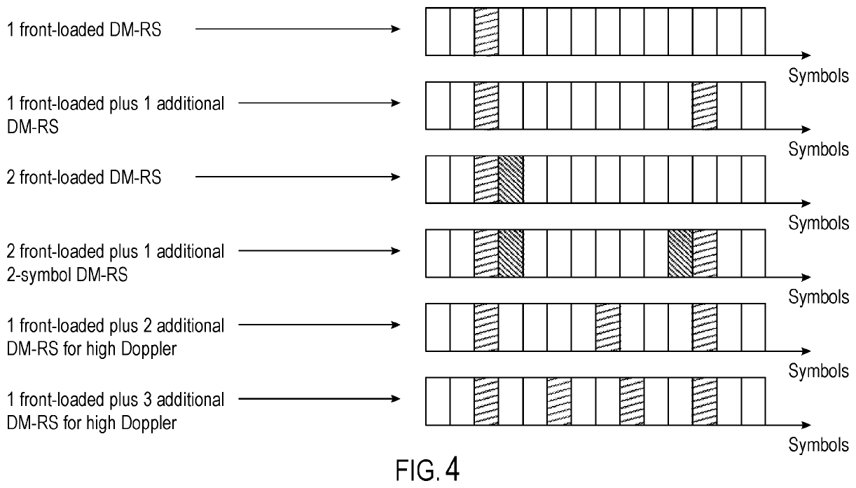

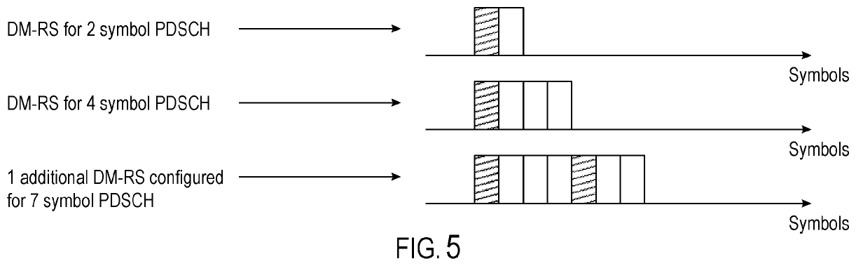

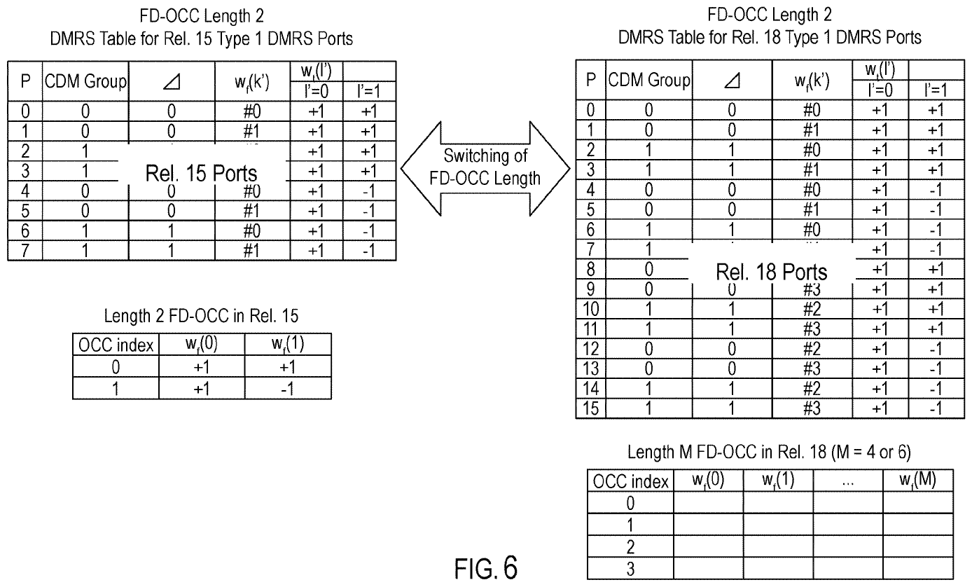

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to perform any step and/or task and/or process and/or method and/or feature described in the present disclosure, e.g., observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may include one or more antennas 76. Radio interface 62 (and/or antennas 76 (which may include ports such as DMRS ports)) may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Arrays) and/or ASICs (Application Specific Integrated Circuitry/Circuits) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 configured to perform any step and/or task and/or process and/or method and/or feature described in the present disclosure, e.g., transmit an indication of a codepoint of an antenna port field in downlink control information (DCI) for scheduling a physical uplink shared channel (PUSCH) the indication indicating at least one spatial layer; and receive signaling, using one or more allocated DMRS ports, according to the indication of the codepoint of the antenna port field.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 include one or more antennas 83. Radio interface 82 (and/or antennas 83 (which may include ports such as DMRS ports)) may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 configured to perform any step and/or task and/or process and/or method and/or feature described in the present disclosure, e.g., receive an indication of a codepoint of an antenna port field in downlink control information (DCI) for scheduling a physical uplink shared channel (PUSCH) the indication indicating at least one spatial layer; and transmit signaling, using one or more allocated DMRS ports, according to the indication of the codepoint of the antenna port field.

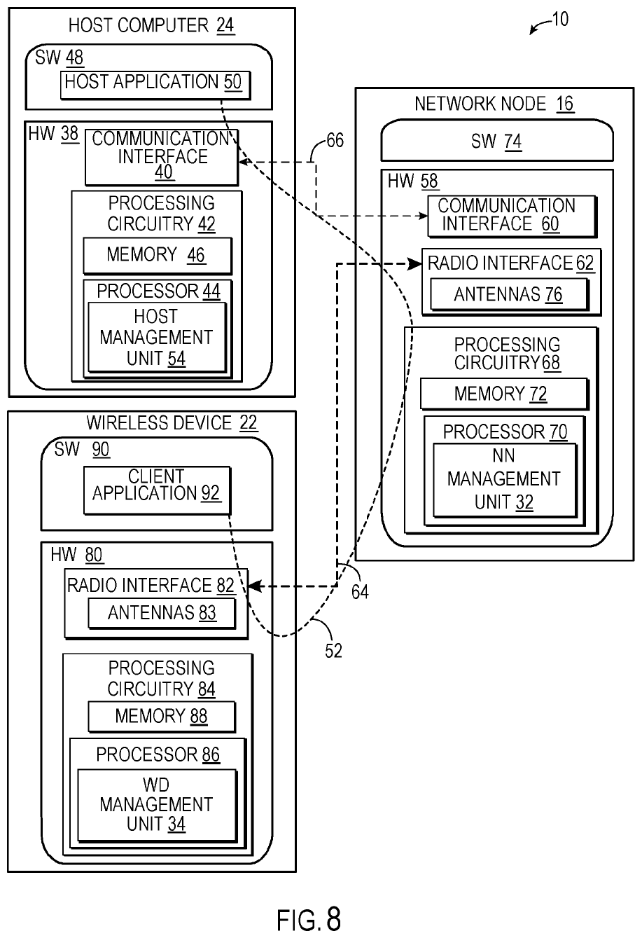

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

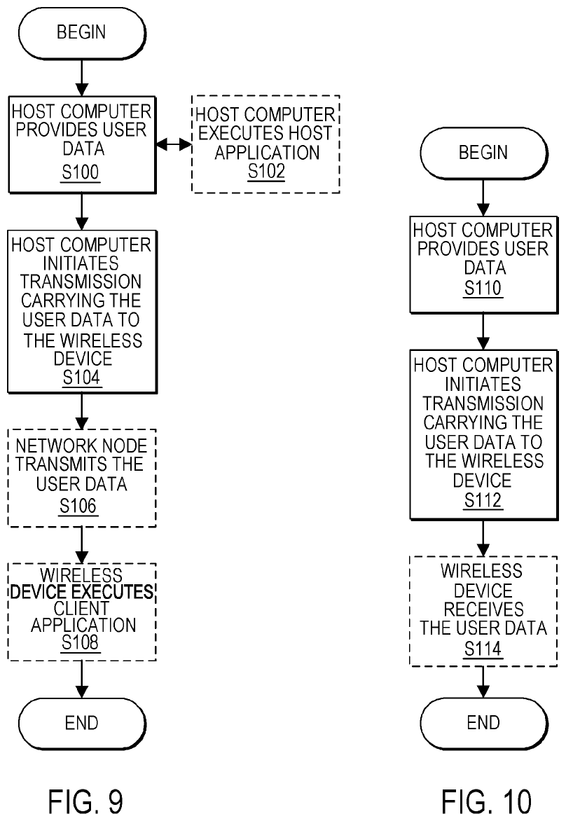

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

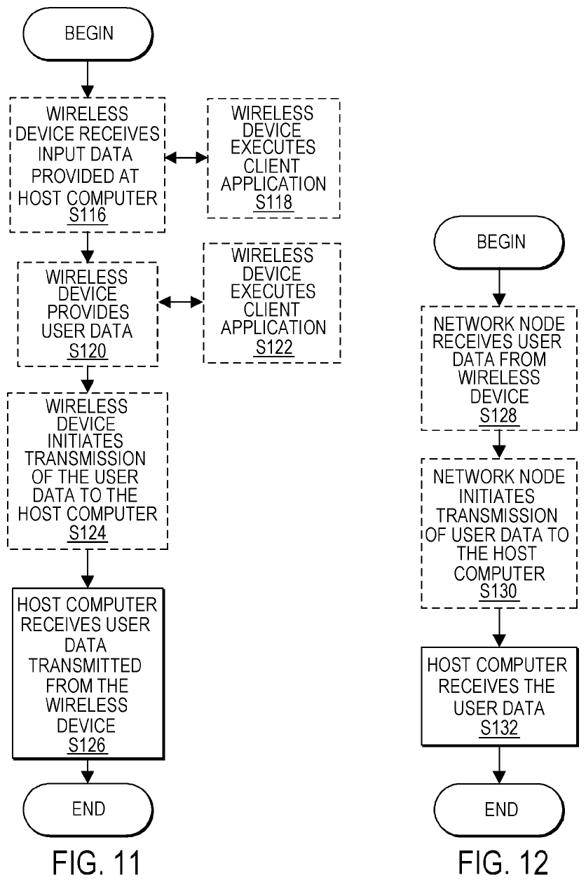

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

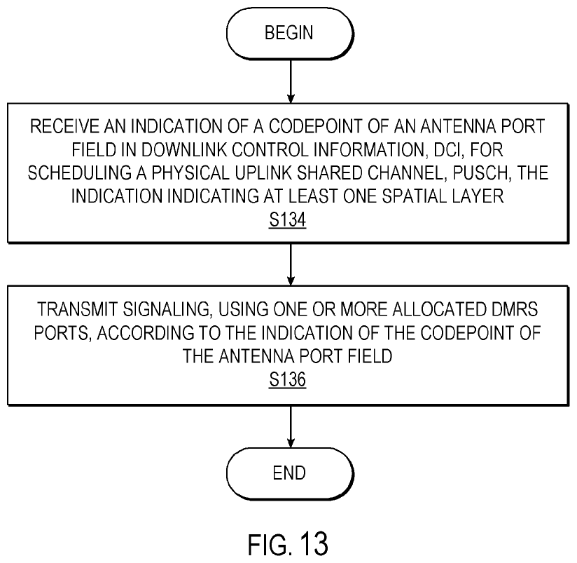

FIG. 13 is a flowchart of an example process in a wireless device 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 is configured to receive (Block S134) an indication of a codepoint of an antenna port field in downlink control information (DCI) for scheduling a physical uplink shared channel (PUSCH), the indication indicating at least one spatial layer; and transmit (cause transmission of) (Block S136) signaling, using one or more allocated DMRS ports, according to the indication of the codepoint of the antenna port field.

In some embodiments, when the at least one spatial layer includes five spatial layers, three DMRS ports are allocated to the first CDM group, and two DMRS ports are allocated to the second CDM group. The two DMRS ports in the second CDM group are mutually super orthogonal.

In some embodiments, the two DMRS ports in the second CDM group are not a predetermined DMRS port.

In some embodiments, when the at least one spatial layer includes five spatial layers, four DMRS ports are allocated to the first CDM group, one DMRS port is allocated to the second CDM group. The DMRS port in the second CDM group is not a predetermined DMRS port.

In some embodiments, when the at least one spatial layer includes six spatial layers, four DMRS ports are allocated to the first CDM group, and two DMRS ports are allocated to the second CDM group. The two DMRS ports in the second CDM group are mutually super orthogonal.

In some embodiments, the two DMRS ports in the second CDM group are not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal, and each one of the two DMRS ports in the third CDM group is not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal. Each one of the two DMRS ports in the second CDM group and each one of the two DMRS ports in the third CDM group is not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal. The two DMRS ports in each CDM group are mutually super orthogonal and not a predetermined DMRS port.

In some embodiments, a number of CDM groups are minimized by utilizing frequency domain orthogonal cover code (FD-OCC) combined with time domain orthogonal cover code (TD-OCC) for a double DMRS symbol.

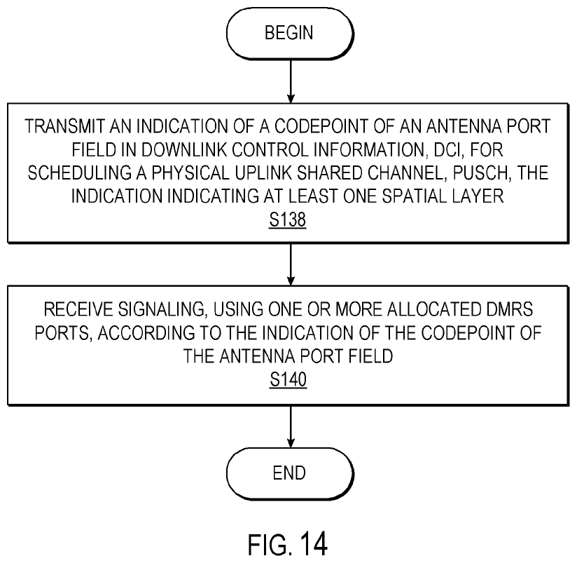

FIG. 14 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to transmit (cause transmission of) (Block S138) an indication of a codepoint of an antenna port field in downlink control information, DCI, for scheduling a physical uplink shared channel, PUSCH, the indication indicating at least one spatial layer; and receive (Block S140) signaling, using one or more allocated DMRS ports, according to the indication of the codepoint of the antenna port field.

In some embodiments, when the at least one spatial layer includes five spatial layers, three DMRS ports are allocated to the first CDM group, and two DMRS ports are allocated to the second CDM group. The two DMRS ports in the second CDM group are mutually super orthogonal.

In some embodiments, the two DMRS ports in the second CDM group are not a predetermined DMRS port.

In some embodiments, when the at least one spatial layer includes five spatial layers, four DMRS ports are allocated to the first CDM group, one DMRS port is allocated to the second CDM group. The DMRS port in the second CDM group is not a predetermined DMRS port.

In some embodiments, when the at least one spatial layer includes six spatial layers, four DMRS ports are allocated to the first CDM group, and two DMRS ports are allocated to the second CDM group. The two DMRS ports in the second CDM group are mutually super orthogonal.

In some embodiments, the two DMRS ports in the second CDM group are not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal, and each one of the two DMRS ports in the third CDM group is not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal. Each one of the two DMRS ports in the second CDM group and each one of the two DMRS ports in the third CDM group is not a predetermined DMRS port.

In some embodiments, when the at least one spatial layer includes six spatial layers for DMRS Type II, two DMRS ports are allocated to the first CDM group, two DMRS ports are allocated to the second CDM group, and two DMRS ports are allocated to a third CDM group. The two DMRS ports in each of CDM group are mutually super orthogonal. The two DMRS ports in each CDM group are mutually super orthogonal and not a predetermined DMRS port.

In some embodiments, a number of CDM groups are minimized by utilizing frequency domain orthogonal cover code (FD-OCC) combined with time domain orthogonal cover code (TD-OCC) for a double DMRS symbol.

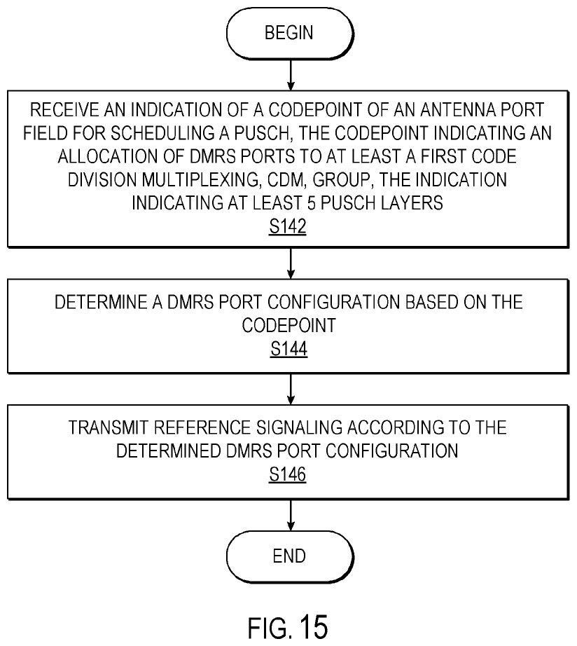

FIG. 15 is a flowchart of an example process in a wireless device 22 according to some embodiments of the present disclosure. One or more blocks described herein may be performed by one or more elements of wireless device 22 such as by one or more of processing circuitry 84 (including the WD management unit 34), processor 86, radio interface 82 and/or communication interface 60. Wireless device 22 is configured to receive an indication of a codepoint of an antenna port field for scheduling a PUSCH, the codepoint indicating an allocation of DMRS ports to at least a first code division multiplexing, CDM, group, the indication indicating at least 5 PUSCH, layers (Block S142). The method includes determining a DMRS port configuration based on the codepoint (Block S144). The method also includes transmitting reference signaling according to the determined DMRS port configuration (Block S146).

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal. In some embodiments, a number of CDM groups are minimized by utilizing frequency domain orthogonal cover code, FD-OCC, combined with time domain orthogonal cover code, TD-OCC, for a double DMRS symbol.

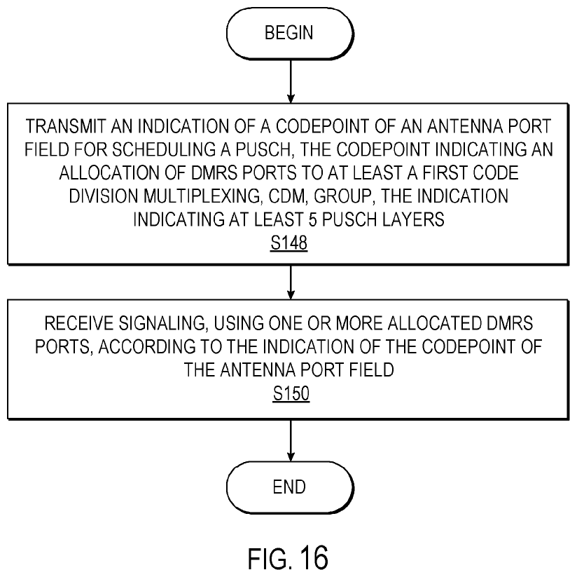

FIG. 16 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 is configured to transmit an indication of a codepoint of an antenna port field for scheduling a PUSCH, the codepoint indicating an allocation of DMRS ports to at least a first code division multiplexing, CDM, group, the indication indicating at least 5 PUSCH layers (Block S148). The method includes receiving signaling, using one or more allocated DMRS ports, according to the indication of the codepoint of the antenna port field (Block S150).

According to this aspect, in some embodiments, the allocation of DMRS ports is configured to maximize a number of mutually super-orthogonal DMRS ports allocated to the first CDM group. In some embodiments, all DMRS ports to be allocated are allocated to the first CDM group using two time division orthogonal cover codes, TD-OCC. In some embodiments, the allocation of DMRS ports is configured to maximize a number of mutually super-orthogonal DMRS ports in a second CDM group. In some embodiments, when a number of spatial layers is five, three DMRS ports are allocated to the first CDM group, and two DMRS ports are allocated to a second CDM group, the two DMRS ports in the second CDM group being mutually super orthogonal. In some embodiments, when a number of spatial layers is six, four DMRS ports are allocated to the first CDM group, and two DMRS ports are allocated to the second CDM group, the two DMRS ports in the second CDM group being mutually super orthogonal. In some embodiments, the two DMRS ports allocated to the second group exclude DMRS port types defined by a first wireless communication standard and include DMRS ports defined by a second wireless communication standard, the second wireless communication standard being released after the first wireless communication standard. In some embodiments, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal. In some embodiments, a number of CDM groups are minimized by utilizing frequency domain orthogonal cover code, FD-OCC, combined with time domain orthogonal cover code, TD-OCC, for a double DMRS symbol.

Although WD 22 has been described as being configured to receive an indication of a codepoint of an antenna port field in DCI for scheduling a PUSCH and transmit signaling, using one or more allocated DMRS ports, according to the indication of the codepoint of the antenna port field, the WD 22 is not limited as such and may be configured to perform on or more functions described with respect to the network node 16. For example, WD 22 may be configured to transmit the indication and receive the signaling. Similarly, the network node 16 may be configured to perform one or more functions described with respect to WD 22, e.g., receive the indication; and/or transmit the signaling.

Having described the general process flow of arrangements of the disclosure and having provided examples of hardware and software arrangements for implementing the processes and functions of the disclosure, the sections below provide details and examples of arrangements for determining antenna port entries for more than four layer PUSCH.

One or more network node functions described below may be performed by one or more of processing circuitry 68, processor 70, NN management unit 32, etc. One or more wireless device functions described below may be performed by one or more of processing circuitry 84, processor 86, WD management unit 34, etc.

$$Definition : If two orthogonal vectors {v}_{1} = [ \begin{matrix}{v}_{1 , 1} \\ … \\ {v}_{1 , K}\end{matrix} ] and {v}_{2} = [ \begin{matrix}{v}_{2 , 1} \\ … \\ {v}_{2 , K}\end{matrix} ] ( {v}_{1}^{H} {v}_{2} = 0 )$$

of sequence length N are orthogonal over every K sequence parts of length N′<N (where N=N′*K), i.e.,

$${v}_{1 , i}^{H} {v}_{2 , i} = 0 , i = 1 , … , K ,$$

the vectors v₁ and v₂ are said to be super-orthogonal.

For example, the vectors of orthogonal cover codes [1 1 1 1] and [1 −1 1 −1] of length four are super-orthogonal as they are also orthogonal over the partial length two.

The property of super-orthogonality between some DMRS ports and the relation to other (e.g., legacy 3GPP Rel-15) DMRS ports is utilized. In DMRS port index Table 9, for eType1, the first 8 rows (ports) are use the same FD-OCC (and TD-OCC) as the 3GPP Rel-15 legacy Type1 table. The ports (p0-p7 for PUSCH and p1000-p1007 for PDSCH) may be referred to as 3GPP Rel-15 Type1 ports in the following description. Similarly, for Table 10 eType2, the first 12 ports may use the same FD-OCC as 3GPP Rel-15 legacy Type2 table. The ports (p0-p11 for PUSCH and p1000-p1011 for PDSCH) may be referred to as 3GPP Rel-15 Type2 ports.

For a receiver to perform channel estimation using multiple DMRS ports (for example a rank 2 reception of 2 ports), it may be beneficial if super-orthogonal DMRS ports are used for the two layers compared to if “only” orthogonal ports are used.

More specifically, if delay-domain channel estimation algorithms are used, a domain transform (such as a DFT) may be used to receive DMRS. Two super-orthogonal ports have a larger sample (i.e., time) separation after the transform compared to two non-super orthogonal ports. This is a property related to at least when there is a delay in the channel which introduce cross-interference between two DMRS ports. For example, to maximize the robustness against channel delays, super-orthogonal DMRS ports may be used, or equivalently, the cyclic shifts of the DMRS port sequences in the time domain may be maximized.

Alternatively, if frequency domain channel estimation algorithms are used, the shorter sequence length N′ to obtain orthogonality between super-orthogonal ports implies that the channel estimator can operate on N′ samples at a time (e.g., instead of N>N′ samples), which makes the system less vulnerable to delay spread/frequency selectivity. The improved channel estimation performance may improve the user throughput, especially for higher order modulation and higher code rates.

The following principles may form the basis for the creation of antenna port indication tables for UL transmission (PUSCH DMRS ports):
DMRS ports assigned to a WD 22 may be using super-orthogonal ports when possible;
DMRS ports assigned to WDs 22s may be orthogonal to legacy DMRS ports, such that legacy WDs 22s and 3GPP Rel-18 WDs 22s can be co-scheduled for UL MU-MIMO;
Use as few CDM groups as possible (for double symbol DMRS), e.g., to allow PUSCH rate matching around DMRS subcarriers.
   Port Numbering for DMRS eType 1 and eType 2

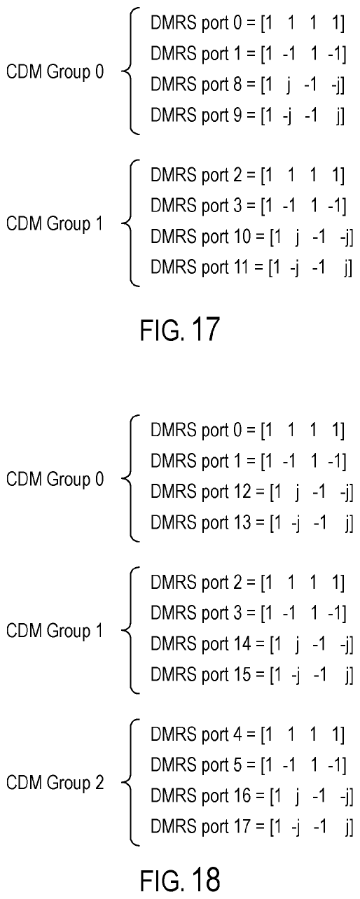

In some embodiments, the following DMRS port number definition for Type 1 DMRS with single DMRS symbol for the 3GPP Rel-18 WDs 22s has been used (e.g., assumed), as illustrated in FIG. 17. DMRS port 0 & DMRS port 1 may be mutually super-orthogonal with each other, which also may be the case for DMRS port 8 & DMRS port 9, for DMRS port 2 & DMRS port 3 and for DMRS port 10 & DMRS port 11.

That is, in one or more embodiments, DMRS port 0 & 1 may be the same as the DMRS port 0 & 1 of the legacy 3GPP Rel-15 DMRS ports, assuming the same DMRS sequences are re-used for DMRS 3GPP Rel-18 as was used for DMRS 3GPP Rel-15. Further, in some embodiments, DMRS port 2 & 3 may the same as the DMRS port 2 & 3 of the legacy 3GPP Rel-15 DMRS ports, e.g., assuming the same DMRS sequences are re-used for DMRS 3GPP Rel-18 as was used for DMRS 3GPP Rel-15/16

FIG. 17 shows an example DMRS port numbering for DMRS type 1 using cyclic shifts. The cyclic shift code may be exchanged to the Hadamard code. FIG. 18 shows example DMRS port numbering for DMRS type 2 using cyclic shifts. That is, the corresponding port numbers for DMRS type 2 are shown. Similar to FIG. 17, the cyclic shift code can be exchanged for the Hadamard code.

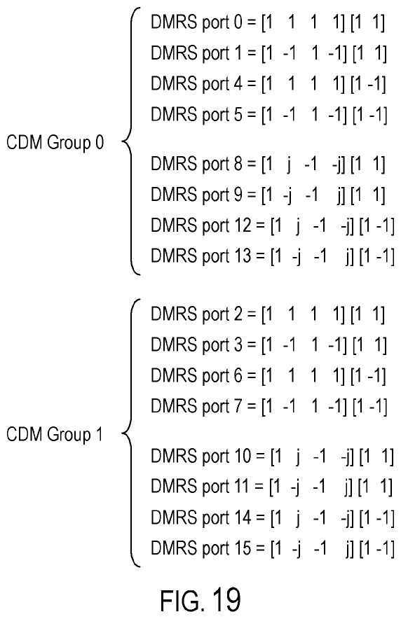

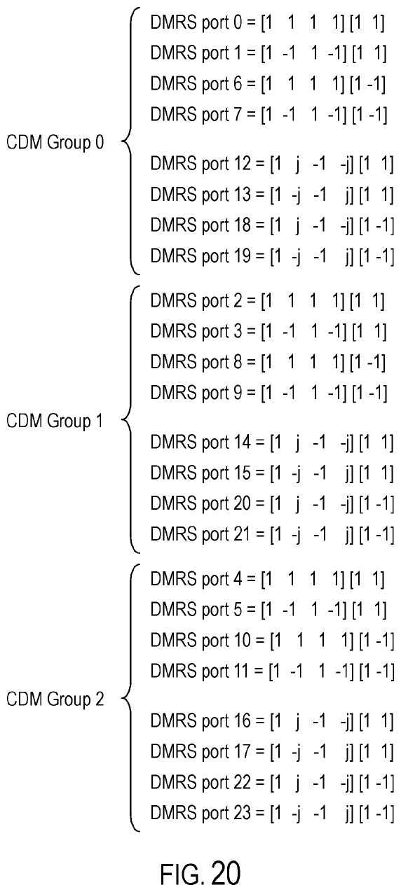

FIGS. 19 and 20 show example DMRS ports numberings for eType1 and eType2 DMRS with 2 front-loaded symbols. For each port, 2 vectors may be used, where a first vector shows an example with cyclic shift FD-OCC code, and the second vector shows the TD-OCC code applied on consecutive DMRS symbols. In some embodiments, the TD-OCC code may be [1, j] or [1, −j] for ports number 8-15 (e.g., instead of using [1 1] and [1 −1] used). More specifically, FIG. 19 shows an example DMRS port numbering for DMRS type 1 with 2 front-loaded symbols using cyclic shifts. FIG. 20 shows an example DMRS port numbering for DMRS type 2 with 2 front-loaded symbols using cyclic shifts. Note that the cyclic shift code may be exchanged for the Hadamard code.

When scheduling the WD 22, the network node 16 (e.g., gNB) indicates in the DCI which antenna (DMRS) ports the WD 22 may use for PUSCH transmission. Such indication may point to a row in an antenna port indication table. The row selection is made in a scheduler of the network node 16 (e.g., gNB) such as by taking into account channel estimation performance, whether data is frequency division multiplexing (FDM) and/or time division multiplexing (TDM) with the DMRS, whether scheduling is a single user (SU) or MU-MIMO scheduling.

In some embodiments, one aspect when designing the UL antenna port tables may be to ensure that the DMRS ports scheduled simultaneously are super-orthogonal to each other when received by network node 16 (e.g., transmission reception point (TRP) and/or gNB), such as to minimize the inter DMRS port interference. Hence, in some embodiments, the antenna port indication table may include rows, where the DMRS port separated by coding (e.g., OCC) within each CDM group and scheduled simultaneously are super-orthogonal (for realistic TRP-WD channel realizations).

Detailed Embodiments on Antenna Port Indication Table for 5 PUSCH Layers and maxLength=1

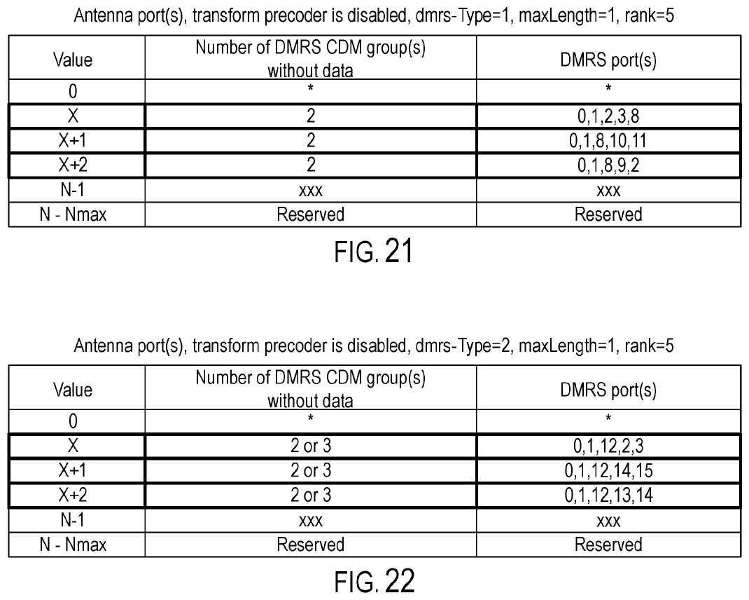

Some detailed examples for DMRS type 1 are illustrated in FIG. 21, e.g., for rank 5. More specifically, FIG. 21 shows example rows in antenna port tables for rank 5 and single symbol DMRS for extended 3GPP Rel-18 DMRS Type 1. In the row associated with codepoint value X, three DMRS ports are allocated to a first CDM group, and two DMRS ports are allocated to the second CDM group. Further, the two DMRS ports in the second CDM group are mutually super orthogonal. In the row associated with codepoint value X+1, three DMRS ports are allocated to a first CDM group, and two DMRS ports are allocated to the second CDM group. The two DMRS ports in the second CDM group are mutually super orthogonal, and the two DMRS ports in the second CDM group are not a 3GPP Rel-15 DMRS port (i.e., a predetermined DMRS port). In the row associated with codepoint value X+2, four DMRS ports are allocated to a first CDM group, and one DMRS port is allocated to the second CDM group. The DMRS port in the second CDM group is not a 3GPP Rel-15 DMRS port.

Some detailed examples for DMRS type 2 are illustrated in FIG. 22, e.g., for rank 5. In the row associated with codepoint value X, three DMRS ports are allocated to a first CDM group, and two DMRS ports are allocated to the second CDM group. The two DMRS ports in the second CDM group are mutually super orthogonal. In the row associated with codepoint value X+1, three DMRS ports are allocated to a first CDM group, and two DMRS ports are allocated to the second CDM group. The two DMRS ports in the second CDM group are mutually super orthogonal, and the two DMRS ports in the second CDM group are not a 3GPP Rel-15 DMRS port. In the row associated with codepoint value X+2, four DMRS ports are allocated to a first CDM group, and one DMRS port is allocated to the second CDM group. The DMRS port in the second CDM group is not a 3GPP Rel-15 DMRS port.

Detailed Embodiments on Antenna Port Indication Table for 6 PUSCH Layers and maxLength=1

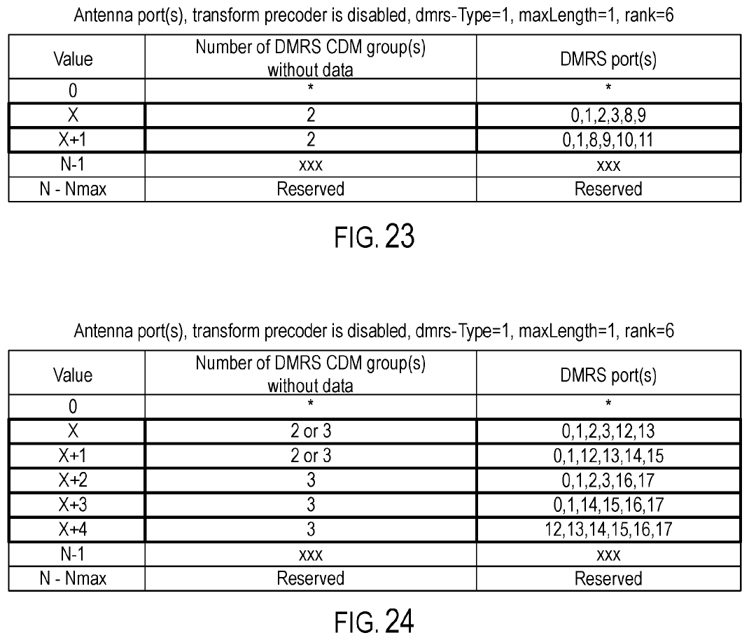

Some detailed examples for DMRS type 1 are illustrated in FIG. 23, e.g., for rank 6. In the row associated with codepoint value X, four DMRS ports are allocated to a first CDM group, and two DMRS ports are allocated to the second CDM group. The two DMRS ports in the second CDM group are mutually super orthogonal. In the row associated with codepoint value X+1, four DMRS ports are allocated to a first CDM group, and two DMRS ports are allocated to the second CDM group. The two DMRS ports in the second CDM group are mutually super orthogonal, and the two DMRS ports in the second CDM group are not a 3GPP Rel-15 DMRS port.

Some detailed examples for DMRS type 2 are illustrated in FIG. 24, e.g., for rank 6. In the row associated with codepoint value X, four DMRS ports are allocated to a first CDM group, and two DMRS ports are allocated to the second CDM group. The two DMRS ports in the second CDM group are mutually super orthogonal. In the row associated with codepoint value X+1, four DMRS ports are allocated to a first CDM group, and two DMRS ports are allocated to the second CDM group. The two DMRS ports in the second CDM group are mutually super orthogonal, and the two DMRS ports in the second CDM group are not a 3GPP Rel-15 DMRS port. In the row associated with codepoint value X+2, two DMRS ports are allocated to a first CDM group, two DMRS ports are allocated to the second CDM group, and two DMRS ports are allocated to a third CDM group. The two DMRS ports in each CDM group are mutually super orthogonal, and the two DMRS ports in the third CDM group are not a 3GPP Rel-15 DMRS port. In the row associated with codepoint value X+3, two DMRS ports are allocated to a first CDM group, two DMRS ports are allocated to the second CDM group, and two DMRS ports are allocated to a third CDM group. The two DMRS ports in each CDM group are mutually super orthogonal, and the two DMRS ports in the second CDM group and the two DMRS ports in the third CDM group are not a 3GPP Rel-15 DMRS port. In the row associated with codepoint value X+4, two DMRS ports are allocated to a first CDM group, two DMRS ports are allocated to the second CDM group, and two DMRS ports are allocated to a third CDM group. The two DMRS ports in each CDM group are mutually super orthogonal and are not a 3GPP Rel-15 DMRS port, in some embodiments

Detailed Embodiments on Antenna Port Indication Table for maxLength=2

In some cases, it may be beneficial to allocate the DMRS ports for PUSCH to a single CDM group to maximize the number of REs that can be used for PUSCH transmission. At least one reason for this is that PUSCH (transmitted from the same WD 22 or other, co-scheduled, WDs 22s) can be rate matched around the unused REs adjacent to the used CDM groups. Hence, the fewer CDM groups that are used for a WD 22, the more REs can be used for PUSCH (e.g., when using only a single CDM group for DMRS type 1 for a WD 22, and there are no co-scheduled WDs 22, PUSCH can be allocated to every second sub-carrier, while if two CDM groups are allocated to the WD 22, no REs in the corresponding DMRS symbols can be used for PUSCH).

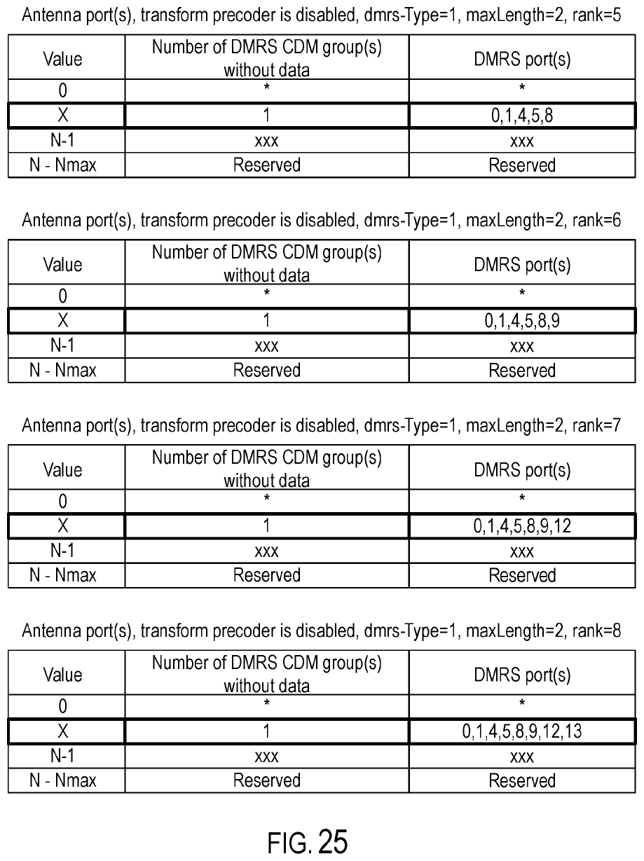

FIG. 25 illustrates some additional rows for antenna port tables for DMRS type I for extended 3GPP Rel-18 DMRS for PUSCH rank 5, 6, 7 and 8 to increase the number of REs for PUSCH (e.g., assuming SU-MIMO).

### Allocating DMRS Ports in Different CDM Groups to Different Codewords

In some embodiments, for uplink transmissions with two codewords, DMRS ports allocated to each codeword may belong to a same CDM group. The DMRS ports in the antenna table may be arranged according to the codeword to layer mapping for more than four layers. This may be useful at least when two WD 22 panels are used, each for transmitting one codeword.

For example, if five layers are scheduled for a PUSCH, the first two layers and the associated DMRS ports are allocated to the first codeword. The remaining three layers and the associated DMRS ports are allocated to the second codeword. In this example, the two DMRS ports (denoted as dmrs ports {n1, n2}) associated to the first codeword are in a same CDM group, and the three DMRS ports (denoted as dmrs ports {m3, m4, m5} associated to the second codeword are in another CDM group. The corresponding configuration in the antenna table is shown in Table 11 below.

TABLE 11
An example of DMRS ports allocation for two codewords
with 5 layers, where DMRS ports {n1, n2}
are in one CDM group and DMRS ports {m3, m4,
m5} are in another different CDM group

| | Number of DMRS CDM | |
|---|---|---|
| Value | group(s) without data | DMRS ports |
| X | 2 or 3 | n1, n2, m3, m4, m5 |

Table 12 shows an example for 6, 7 and 8 layers, where the DMRS ports {nk, k=1, 2, 3, 4} are in one CDM group, and the DMRS ports {mk, k=1, 2, 3, 4} are in another different CDM group.

TABLE 12
An example of DMRS ports allocation for two codewords
with more than 5 layers, where DMRS ports {n1,
n2} are in one CDM group and DMRS ports {n3,
n4, n5} are in another CDM group

| | Number of DMRS CDM | |
|---|---|---|
| Value | group(s) without data | DMRS ports |
| a | 2 or 3 | n1, n2, n3, m4, m5, m6 |
| b | 2 or 3 | n1, n2, n3, m4, m5, m6, m7 |
| c | 2 or 3 | n1, n2, n3, n4, m5, m6, m7, m8 |

Some embodiments may include one or more of the following:

Embodiment A1. A wireless device, WD, configured to communicate with a network node, the WD being configured for allocating demodulation reference signal, DMRS, ports for physical uplink shared channel, PUSCH, transmission, the DMRS ports being allocated to at least one of a first code division multiplexing, CDM, group and a second CDM group, the WD being scheduled with more than four PUSCH layers and configured to, and/or comprising a radio interface and/or processing circuitry configured to:
receive an indication of a codepoint of an antenna port field in downlink control information, DCI, for scheduling a physical uplink shared channel, PUSCH, the indication indicating at least one spatial layer; and
transmit signaling, using one or more allocated DMRS ports, according to the indication of the codepoint of the antenna port field.

Embodiment A2. The WD of Embodiment A1, wherein, when the at least one spatial layer includes five spatial layers, three DMRS ports are allocated to the first CDM group, and two DMRS ports are allocated to the second CDM group, the two DMRS ports in the second CDM group being mutually super orthogonal.

Embodiment A3. The WD of Embodiment A2, wherein the two DMRS ports in the second CDM group are not a predetermined DMRS port.

Embodiment A4. The WD of Embodiment A1, wherein, when the at least one spatial layer includes five spatial layers, four DMRS ports are allocated to the first CDM group, one DMRS port is allocated to the second CDM group, the DMRS port in the second CDM group is not a predetermined DMRS port.

Embodiment A5. The WD of any one of Embodiments A1-A4, wherein, when the at least one spatial layer includes six spatial layers, four DMRS ports are allocated to the first CDM group, and two DMRS ports are allocated to the second CDM group, the two DMRS ports in the second CDM group being mutually super orthogonal.

Embodiment A6. The WD of Embodiment A5, wherein the two DMRS ports in the second CDM group are not a predetermined DMRS port.

Embodiment A7. The WD of any one of Embodiments A1-A6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the third CDM group not being a predetermined DMRS port.

Embodiment A8. The WD of any one of Embodiments A1-A6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the second CDM group and each one of the two DMRS ports in the third CDM group not being a predetermined DMRS port.

Embodiment A9. The WD of any one of Embodiments A1-A6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, the two DMRS ports in each CDM group being mutually super orthogonal and not a predetermined DMRS port.

Embodiment A10. The WD of any one of Embodiments A1-A9, wherein, a number of CDM groups are minimized by utilizing frequency domain orthogonal cover code, FD-OCC, combined with time domain orthogonal cover code, TD-OCC, for a double DMRS symbol.

Embodiment B1. A method implemented in a wireless device, WD, configured to communicate with a network node, the WD being configured for allocating demodulation reference signal, DMRS, ports for physical uplink shared channel, PUSCH, transmission, the DMRS ports being allocated to at least one of a first code division multiplexing, CDM, group and a second CDM group, the WD being scheduled with more than four PUSCH layers, the method comprising:
receiving an indication of a codepoint of an antenna port field in downlink control information, DCI, for scheduling a physical uplink shared channel, PUSCH, the indication indicating at least one spatial layer; and
transmitting signaling, using one or more allocated DMRS ports, according to the indication of the codepoint of the antenna port field.

Embodiment B2. The method of Embodiment B1, wherein, when the at least one spatial layer includes five spatial layers, three DMRS ports are allocated to the first CDM group, and two DMRS ports are allocated to the second CDM group, the two DMRS ports in the second CDM group being mutually super orthogonal.

Embodiment B3. The method of Embodiment B2, wherein the two DMRS ports in the second CDM group are not a predetermined DMRS port.

Embodiment B4. The method of Embodiment B1, wherein, when the at least one spatial layer includes five spatial layers, four DMRS ports are allocated to the first CDM group, one DMRS port is allocated to the second CDM group, the DMRS port in the second CDM group is not a predetermined DMRS port.

Embodiment B5. The method of any one of Embodiments B1-B4, wherein, when the at least one spatial layer includes six spatial layers, four DMRS ports are allocated to the first CDM group, and two DMRS ports are allocated to the second CDM group, the two DMRS ports in the second CDM group being mutually super orthogonal. Embodiment B6. The method of Embodiment B5, wherein the two DMRS ports in the second CDM group are not a predetermined DMRS port.

Embodiment B7. The method of any one of Embodiments B1-B6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the third CDM group not being a predetermined DMRS port.

Embodiment B8. The method of any one of Embodiments B1-B6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the second CDM group and each one of the two DMRS ports in the third CDM group not being a predetermined DMRS port.

Embodiment B9. The method of any one of Embodiments B1-B6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, the two DMRS ports in each CDM group being mutually super orthogonal and not a predetermined DMRS port.

Embodiment B10. The method of any one of Embodiments B1-B9, wherein, a number of CDM groups are minimized by utilizing frequency domain orthogonal cover code, FD-OCC, combined with time domain orthogonal cover code, TD-OCC, for a double DMRS symbol.

Embodiment C1. A network node configured to communicate with a wireless device, WD, the WD being configured for allocating demodulation reference signal, DMRS, ports for physical uplink shared channel, PUSCH, transmission, the DMRS ports being allocated to at least one of a first code division multiplexing, CDM, group and a second CDM group, the WD being scheduled with more than four PUSCH layers and configured to, and/or comprising a radio interface and/or processing circuitry configured to:
transmit an indication of a codepoint of an antenna port field in downlink control information, DCI, for scheduling a physical uplink shared channel, PUSCH, the indication indicating at least one spatial layer; and
receive signaling, using one or more allocated DMRS ports, according to the indication of the codepoint of the antenna port field.

Embodiment C2. The network node of Embodiment C1, wherein, when the at least one spatial layer includes five spatial layers, three DMRS ports are allocated to the first CDM group, and two DMRS ports are allocated to the second CDM group, the two DMRS ports in the second CDM group being mutually super orthogonal.

Embodiment C3. The network node of Embodiment C2, wherein the two DMRS ports in the second CDM group are not a predetermined DMRS port.

Embodiment C4. The network node of Embodiment C1, wherein, when the at least one spatial layer includes five spatial layers, four DMRS ports are allocated to the first CDM group, one DMRS port is allocated to the second CDM group, the DMRS port in the second CDM group is not a predetermined DMRS port.

Embodiment C5. The network node of any one of Embodiments C1-C4, wherein, when the at least one spatial layer includes six spatial layers, four DMRS ports are allocated to the first CDM group, and two DMRS ports are allocated to the second CDM group, the two DMRS ports in the second CDM group being mutually super orthogonal.

Embodiment C6. The network node of Embodiment C5, when the two DMRS ports in the second CDM group are not a predetermined DMRS port.

Embodiment C7. The network node of any one of Embodiments C1-C6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the third CDM group not being a predetermined DMRS port.

Embodiment C8. The network node of any one of Embodiments C1-C6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the second CDM group and each one of the two DMRS ports in the third CDM group not being a predetermined DMRS port.

Embodiment C9. The network node of any one of Embodiments C1-C6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, the two DMRS ports in each CDM group being mutually super orthogonal and not a predetermined DMRS port.

Embodiment C10. The network node of any one of Embodiments C₁-C₉, wherein, a number of CDM groups are minimized by utilizing frequency domain orthogonal cover code, FD-OCC, combined with time domain orthogonal cover code, TD-OCC, for a double DMRS symbol.

Embodiment D1. A method implemented in a network node configured to communicate with a wireless device, WD, the WD being configured for allocating demodulation reference signal, DMRS, ports for physical uplink shared channel, PUSCH, transmission, the DMRS ports being allocated to at least one of a first code division multiplexing, CDM, group and a second CDM group, the WD being scheduled with more than four PUSCH layers, the method comprising:
transmitting an indication of a codepoint of an antenna port field in downlink control information, DCI, for scheduling a physical uplink shared channel, PUSCH, the indication indicating at least one spatial layer; and
receiving signaling, using one or more allocated DMRS ports, according to the indication of the codepoint of the antenna port field.

Embodiment D2. The method of Embodiment D1, wherein, when the at least one spatial layer includes five spatial layers, three DMRS ports are allocated to the first CDM group, and two DMRS ports are allocated to the second CDM group, the two DMRS ports in the second CDM group being mutually super orthogonal.

Embodiment D3. The method of Embodiment D2, wherein the two DMRS ports in the second CDM group are not a predetermined DMRS port.

Embodiment D4. The method of Embodiment D1, wherein, when the at least one spatial layer includes five spatial layers, four DMRS ports are allocated to the first CDM group, one DMRS port is allocated to the second CDM group, the DMRS port in the second CDM group is not a predetermined DMRS port.

Embodiment D5. The method of any one of Embodiments D1-D4, wherein, when the at least one spatial layer includes six spatial layers, four DMRS ports are allocated to the first CDM group, and two DMRS ports are allocated to the second CDM group, the two DMRS ports in the second CDM group being mutually super orthogonal. Embodiment D6. The method of Embodiment D5, wherein the two DMRS ports in the second CDM group are not a predetermined DMRS port.

Embodiment D7. The method of any one of Embodiments D1-D6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the third CDM group not being a predetermined DMRS port.

Embodiment D8. The method of any one of Embodiments D1-D6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, each one of the two DMRS ports in the second CDM group and each one of the two DMRS ports in the third CDM group not being a predetermined DMRS port.

Embodiment D9. The method of any one of Embodiments D1-D6, wherein, when the at least one spatial layer includes six spatial layers for DMRS Type II, two DMRS ports are allocated to the first CDM group, two DMRS ports are allocated to the second CDM group, and two DMRS ports are allocated to a third CDM group, the two DMRS ports in each of CDM group being mutually super orthogonal, the two DMRS ports in each CDM group being mutually super orthogonal and not a predetermined DMRS port.

Embodiment D10. The method of any one of Embodiments D1-D9, wherein, a number of CDM groups are minimized by utilizing frequency domain orthogonal cover code, FD-OCC, combined with time domain orthogonal cover code, TD-OCC, for a double DMRS symbol.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD being configured for allocating demodulation reference signal, DMRS, ports for physical uplink shared channel, PUSCH, transmission, the WD configured to:
receive an indication of a codepoint of an antenna port field for scheduling a PUSCH, the codepoint indicating an allocation of DMRS ports to at least a first code division multiplexing, CDM, group, the indication indicating at least 5 PUSCH layers;
determine a DMRS port configuration based at least in part on the codepoint; and
transmit reference signaling according to the determined DMRS port configuration.

2. The WD of claim 1, wherein the allocation of DMRS ports is configured to maximize a number of mutually super-orthogonal DMRS ports allocated to the first CDM group.

3. The WD of claim 1, wherein all DMRS ports to be allocated are allocated to the first CDM group using two time division orthogonal cover codes, TD-OCC.

4. The WD of claim 1, wherein the allocation of DMRS ports is configured to maximize a number of mutually super-orthogonal DMRS ports in a second CDM group.

5.-8. (canceled)

9. A method in a wireless device, WD, configured to communicate with a network node, the WD being configured for allocating demodulation reference signal, DMRS, ports for physical uplink shared channel, PUSCH, transmission, the method comprising:
receiving an indication of a codepoint of an antenna port field for scheduling a PUSCH, the codepoint indicating an allocation of DMRS ports to at least a first code division multiplexing, CDM, group, the indication indicating at least 5 PUSCH, layers;
determining a DMRS port configuration based at least in part on the codepoint; and
transmitting reference signaling according to the determined DMRS port configuration.

10. The method of claim 9, wherein the allocation of DMRS ports is configured to maximize a number of mutually super-orthogonal DMRS ports allocated to the first CDM group.

11. The method of claim 9, wherein all DMRS ports to be allocated are allocated to the first CDM group using two time division orthogonal cover codes, TD-OCC.

12. The method of claim 9, wherein the allocation of DMRS ports is configured to maximize a number of mutually super-orthogonal DMRS ports in a second CDM group.

13. The method of claim 9, wherein, when a number of spatial layers is five, three DMRS ports are allocated to the first CDM group, and two DMRS ports are allocated to a second CDM group, the two DMRS ports in the second CDM group being mutually super orthogonal.

14. The method of claim 9, wherein, when a number of spatial layers is six, four DMRS ports are allocated to the first CDM group, and two DMRS ports are allocated to the second CDM group, the two DMRS ports in the second CDM group being mutually super orthogonal.

15. The method of claim 9, wherein, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal.

16. The method of claim 9, wherein, a number of CDM groups are minimized by utilizing frequency domain orthogonal cover code, FD-OCC, combined with time domain orthogonal cover code, TD-OCC, for a double DMRS symbol.

17.-24. (canceled)

25. A method in a network node configured to communicate with a wireless device, WD, the WD being configured for allocating demodulation reference signal, DMRS, ports for physical uplink shared channel, PUSCH, transmission, the method comprising:
transmitting an indication of a codepoint of an antenna port field for scheduling a PUSCH, the codepoint indicating an allocation of DMRS ports to at least a first code division multiplexing, CDM, group, the indication indicating at least 5 PUSCH, layers; and
receiving signaling, using one or more allocated DMRS ports, according to the indication of the codepoint of the antenna port field.

26. The method of claim 25, wherein the allocation of DMRS ports is configured to maximize a number of mutually super-orthogonal DMRS ports allocated to the first CDM group.

27. The method of claim 25, wherein all DMRS ports to be allocated are allocated to the first CDM group using two time division orthogonal cover codes, TD-OCC.

28. The method of claim 25, wherein the allocation of DMRS ports is configured to maximize a number of mutually super-orthogonal DMRS ports in a second CDM group.

29. The method of claim 25, wherein, when a number of spatial layers is five, three DMRS ports are allocated to the first CDM group, and two DMRS ports are allocated to a second CDM group, the two DMRS ports in the second CDM group being mutually super orthogonal.

30. The method of claim 25, wherein, when a number of spatial layers is six, four DMRS ports are allocated to the first CDM group, and two DMRS ports are allocated to the second CDM group, the two DMRS ports in the second CDM group being mutually super orthogonal.

31. The method of claim 25, wherein, when a number of spatial layers is six, two DMRS ports are allocated to the first CDM group, two DMRS ports are allocated to the second CDM group, and two DMRS ports are allocated to a third CDM group, the two DMRS ports in each of CDM group being mutually super orthogonal.

32. The method of claim 25, wherein, a number of CDM groups are minimized by utilizing frequency domain orthogonal cover code, FD-OCC, combined with time domain orthogonal cover code, TD-OCC, for a double DMRS symbol.
